(19) United States
(12) Patent Application Publication
(10) Pub. No.: US 2026/0078036 A1
(43) Pub. Date: Mar. 19, 2026

(54) APPARATUS FOR ABSORPTION OF CONTAMINANTS

(71) Applicant: Carbon Smart LLC, Salem, VA (US)

(72) Inventors: Xan Michele Difede, Kemah, TX (US); Ricky Kyle Barton, Jr., Pounding Mill, VA (US)

(21) Appl. No.: 19/329,178

(22) Filed: Sep. 15, 2025

Related U.S. Application Data
(60) Provisional application No. 63/694,705, filed on Sep. 13, 2024.

(51) Int. Cl. C02F 3/10; C02F 3/00; C02F 3/34

(52) U.S. Cl. CPC C02F 3/106; C02F 3/104; C02F 3/347; C02F 2003/001

(57) ABSTRACT

The present disclosure provides an apparatus for absorption of contaminants. Further, the apparatus may include a substrate comprised of one or more of a biodegradable material and a non-biodegradable material. Further, the apparatus may include an absorbent medium incorporated with the substrate. Further, the apparatus may be configured to be disposed on a surface. Further, the absorbent medium includes a biochar. Further, the absorbent medium may be configured for absorbing one or more contaminants from one or more of the surface and an environment associated with the surface.

### FIELD OF DISCLOSURE

The present disclosure generally relates to the field of Hydraulic and Earth Engineering. More specifically, the present disclosure relates to an apparatus for absorption of contaminants.

### BACKGROUND

The field of environmental remediation focuses on methods and technologies aimed at restoring contaminated environments to their natural state. Soil contamination poses significant threats to ecosystems and human health due to the adverse effects of pollutants such as heavy metals, organic compounds, and pathogens. These contaminants can seep into groundwater, affecting water supplies and causing long-term ecological damage. Therefore, effective strategies for removing or neutralizing contaminants are crucial for preserving environmental integrity.

An important objective in this field is to develop innovative solutions that can efficiently remove or store harmful substances from soil. Traditional methods often involve chemical treatments, which can be costly and may pose additional risks. Additionally, existing remediation techniques might not address all types of contaminants effectively or adapt well to varying environmental conditions.

Existing techniques for preventing soil contamination are deficient with regard to several aspects. Watershed contamination along roadsides has long been a problem. For instance, current techniques have no medium (except natural organic growth) to create a buffer between road contaminants and the watershed.

One of the key challenges in current remediation practices is the limited effectiveness of certain technologies. For instance, some methods fail to completely break down diverse types of pollutants, leading to only partial remediation. Furthermore, existing systems may lack scalability, making them unsuitable for large-scale applications. There is also a need for solutions that can simultaneously address issues like soil erosion and carbon sequestration, providing comprehensive environmental benefits.

Therefore, there is a need for an improved apparatus for absorption of contaminants that can overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides an apparatus for absorption of contaminants. Further, the apparatus may include a substrate comprised of one or more of a biodegradable material and a non-biodegradable material. For instance, in some embodiments, the non-biodegradable material may include vinyl and/or derivatives thereof. Further, the apparatus may include an absorbent medium incorporated with the substrate. Further, the apparatus may be configured to be disposed on a surface. Further, the absorbent medium includes a biochar. Further, the absorbent medium may be configured for absorbing one or more contaminants from one or more of the surface and an environment associated with the surface.

Further, in some embodiments, the apparatus may be placed to regulate moisture of one or more of the surface and the environment.

The present disclosure provides an apparatus for absorption of one or more of carbon and moisture. Further, the apparatus may include a substrate comprised of one or more of a biodegradable material and a non-biodegradable material. Further, the apparatus may include an absorbent medium incorporated with the substrate. Further, the apparatus may be configured to be disposed on a surface. Further, the absorbent medium includes a biochar. Further, the absorbent medium may be configured for absorbing one or more of the carbon and the moisture from one or more of the surface and an environment associated with the surface.

The present disclosure provides an apparatus for providing a habitat for microorganisms. Further, the apparatus may include a substrate comprised of one or more of a biodegradable material and a non-biodegradable material. Further, the apparatus may include an absorbent medium incorporated with the substrate. Further, the apparatus may be configured to be disposed on a surface. Further, the absorbent medium includes a biochar. Further, the absorbent medium includes one or more microorganisms. Further, the apparatus may be configured to maintain a controlled environment condition for providing the habitat for one or more microorganisms.

The present disclosure provides an apparatus for absorption of contaminants. Further, the apparatus may include a substrate comprised of one or more of a biodegradable material and a non-biodegradable material. Further, the apparatus may include an absorbent medium incorporated with the substrate. Further, the apparatus may be configured to be disposed on a surface. Further, the absorbent medium includes a biochar. Further, the absorbent medium may be configured for absorbing one or more contaminants from one or more of the surface and an environment. Further, the absorbent medium further includes one or more microorganisms. Further, the one or more microorganisms decompose the one or more contaminants absorbed by the absorbent medium.

The present disclosure provides an apparatus for absorption of contaminants. Further, the apparatus may include a substrate comprised of one or more of a biodegradable material and a non-biodegradable material. Further, the apparatus may include an absorbent medium incorporated with the substrate. Further, the apparatus may be configured to be disposed on a surface. Further, the absorbent medium includes a biochar. Further, the absorbent medium may be configured for absorbing one or more contaminants from one or more of the surface and an environment associated with the surface. Further, the absorbent medium further includes one or more seeds. Further, the one or more seeds germinate into one or more seedlings. Further, the one or more seedlings absorb one or more carbon compounds from the environment.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a side view of an apparatus 100 for absorption of contaminants, in accordance with some embodiments.

FIG. 2 illustrates a side view of the apparatus 100 for absorption of contaminants with the second substrate 202, in accordance with some embodiments.

FIG. 3 illustrates a side view of the apparatus 100 for absorption of contaminants with the second substrate 202, in accordance with some embodiments.

FIG. 4 illustrates an exploded view of the apparatus 100 for absorption of contaminants, in accordance with some embodiments.

FIG. 5 illustrates an apparatus 500 for absorption of contaminants, in accordance with some embodiments.

FIG. 6 illustrates an apparatus 600 disposed on a surface, in accordance with some embodiments.

FIG. 7 illustrates a flow chart of a method 700 for facilitating preventing of soil contamination, in accordance with some embodiments.

FIG. 8 illustrates a side view of an apparatus 800 for absorption of contaminants, in accordance with some embodiments.

FIG. 9 illustrates a side view of an apparatus 900 for absorption of contaminants, in accordance with some embodiments.

FIG. 10 illustrates a side view of an apparatus 1000 for providing a habitat for microorganisms, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

### OVERVIEW

The present disclosure describes a composition for facilitating prevention of soil contamination. Further, the disclosed composition may be a carbon-based biochar inoculated with mycelium, microorganism fuel, and a specific seed mix based on geography and carbon drawdown capacity. The disclosed composition may then be added to, but not limited to, an entry vehicle like an erosion prevention mat or some other mat-like structure that may be placed in the targeted area. Once in place, the natural breakdown and decomposition of material comprised in the composition may begin. The microorganism colonies and mycelium may begin to grow. Further, the biochar may absorb a targeted material, and the mycelium may start to consume the targeted material and break the targeted material down. This process may happen automatically with very little maintenance over time. The selected seeds may begin to draw down carbon and store the carbon in the absorbent medium, creating a carbon focused product that solves a contamination problem.

The present disclosure further describes an apparatus for facilitating prevention of soil contamination. Accordingly, the apparatus may include a carrier element. Further, in an instance, the carrier element may include a mat. Further, in an instance, the carrier element may include a pod. Further, the carrier element may be comprised of the composition. Further, the mat may include an erosion prevention mat. Further, the mat may be placed in the targeted area. Further, the mat may include the tackified mat and the needlepunched mat. Further, the apparatus may be used for soil contamination prevention (thus preventing watershed contamination), soil remediation, and improving overall soil quality. Further, the apparatus may be configured for preventing watershed contamination and providing soil remediation in general, along with improving soil quality and an engineered ecosystem for microorganisms.

Further, the present disclosure describes methods, apparatuses, and compositions for facilitating prevention of soil contamination. Further, the disclosed composition may stabilize the soil's nutrients. The disclosed composition may include an absorbent medium that is organic and may naturally store or consume most contaminants. Atmospheric carbon has been proven to increase Earth's temperature through a phenomenon called the greenhouse effect. The disclosed composition contains an organic carbon derived from waste streams that may be placed in the soil and permanently stored. This carbon storage may replace the natural event of carbon flux that would have otherwise happened to the feedstock and been released back into the atmosphere. Also, the presence of this carbon-based medium encourages the added storage of soil organic carbon by creating an environment conducive to microorganism colony growth. Further, the mat may be used for certain applications, wherein the mat may be perforated so that the mat may be used in smaller areas, such as gardens or when planting trees.

Further, the mat by nature will capture methane because microorganisms will grow within the biochar organically. Further, to jumpstart the process, the biochar is inoculated with microorganisms. Further, the biochar is impregnated with microorganisms to capture methane.

Further, the apparatus includes mats and pods with biochar that could be impregnated or not with mycelium spores. Also, the mats impregnated with microbials are designed for methane capture from air and/or soil.

The stabilization of soil and prevention of contamination require a secure foundation for the mat-like structure. If the barrier is not properly anchored, the mat-like structure may shift or become dislodged, leading to instability and potential failure in its function. Further, the organic tackifier may be selected based on specific environmental conditions, such as soil type or moisture content. For example, a tackifier derived from plant-based polymers may provide better stability in wetter environments, whereas a tackifier made from synthetic copolymers may be more suitable for drier soils.

Further, the apparatus creates a dramatically improved habitat for naturally occurring microorganisms. The problem is oftentimes a less than perfect environment for problem-solving microorganisms to do the microorganism's job. A very strong advantage of the apparatus is to create an aerobic space for naturally occurring microorganisms to multiply and thrive. The mat would be an (engineered ecosystem environment) built to encourage survival and population of naturally occurring beneficial microorganism colonies. The magic is in creating a “reef-like” space for microorganisms to do the microorganism's work. Also, not all mats are biodegradable.

### Here are the 10 Best Use Cases:

1. Enhanced Bioremediation and Wastewater Treatment: A layered biochar mat, especially with varying pore sizes and amendments, could act as a highly efficient, aerobic bioreactor for treating contaminated water. The large surface area and porous structure of biochar would provide an ideal habitat for aerobic microbes to break down pollutants (e.g., pharmaceuticals, pesticides, heavy metals). An aerobic system could be created by incorporating larger biochar particles or even incorporating small, permeable tubes within the mat to facilitate air circulation, significantly improving the degradation rate compared to traditional anoxic or anaerobic systems. This might revolutionize municipal and industrial wastewater treatment plants, making them more sustainable and effective.
2. Advanced Green Roof and Living Wall Substrates: Biochar mats offer a lightweight, nutrient-retentive, and aerated alternative to traditional growing media in green roofs and living walls. The mat format would prevent substrate migration and provide excellent drainage while retaining moisture, crucial for plant health in these exposed environments. A layered mat might be designed with a more porous, aerobic layer at the bottom for root aeration and a finer, water-retentive layer at the top. This would improve plant vigor, reduce irrigation needs, and enhance the insulating properties of the structures, making buildings more energy-efficient.
3. Sustainable Agricultural Soil Amendment and Erosion Control: Deploying biochar mats directly onto agricultural fields might offer a dual benefit: gradually releasing biochar into the soil as it degrades, improving soil structure, water retention, and nutrient availability, while simultaneously providing immediate erosion control. The mat's structure would allow for water infiltration while preventing soil runoff. An aerobic environment within the mat, particularly if designed with a loosely packed upper layer, would support beneficial soil microbes and improve root respiration, leading to healthier crops and reduced topsoil loss.
4. Odor Control and Air Filtration in Livestock and Industrial Settings: Biochar's excellent adsorptive properties make the biochar ideal for capturing volatile organic compounds (VOCs) and ammonia. A biochar mat might be used as a filter in ventilation systems of barns, waste treatment facilities, or industrial sites to significantly reduce unpleasant odors and improve air quality. A layered design, perhaps with an outer, more permeable layer to maximize air contact and an inner, denser layer for adsorption, would enhance its efficiency. The inherent porosity might facilitate aerobic degradation of some adsorbed compounds, prolonging the filter's life.
5. Bioregenerative Life Support Systems (e.g., Space Habitats, Closed-Loop Greenhouses): For long-duration space missions or closed-loop terrestrial greenhouses, a biochar mat might be a key component in a bioregenerative life support system. The biochar might serve as a growth medium for plants, filtering water and air, and supporting microbial communities for waste decomposition and nutrient cycling. The ability to create an aerobic environment within the mat would be crucial for efficient decomposition of organic waste and healthy plant root development in these highly controlled environments, potentially replacing more complex and energy-intensive physicochemical systems.
6. Stormwater Management and Filtration Swales: Instead of traditional gravel or sand filters, a biochar mat might be integrated into stormwater swales and rain gardens. Biochar's high surface area and porous structure would effectively filter out pollutants (e.g., hydrocarbons, heavy metals, excess nutrients) from runoff, preventing them from entering natural water bodies. The mat's ability to facilitate an aerobic environment would promote the biodegradation of organic pollutants. This would make urban and suburban stormwater management systems far more effective and environmentally friendly.
7. Controlled Release Fertilizer and Pesticide Delivery Systems: Biochar can adsorb and slowly release nutrients and agrochemicals. A biochar mat might be engineered as a “smart” delivery system for fertilizers or even beneficial microbes. Applied directly to the root zone, the mat would reduce nutrient leaching and improve uptake efficiency. A layered mat might control the release rate by varying biochar particle size and density, ensuring nutrients are available when needed. The aerobic nature of the mat would also support microbial communities that aid in nutrient cycling.
8. Bio-inspired Construction Materials for Moisture Regulation and Indoor Air Quality: Integrating biochar mats into building materials (e.g., walls, ceilings) might create passive systems for regulating indoor humidity and filtering air. The porous structure of biochar would absorb excess moisture and release it when the air is dry, acting as a natural dehumidifier. Furthermore, the biochar might adsorb indoor air pollutants like formaldehyde or VOCs. An aerobic environment within the mat structure would help to prevent mold growth and potentially facilitate the biodegradation of some adsorbed pollutants, leading to healthier indoor environments.
9. Enhanced Composting and Anaerobic Digestion Efficiency: Incorporating biochar mats into composting piles or as a component within anaerobic digesters might significantly improve the efficiency of these processes. In composting, the mat might provide aeration and a large surface area for microbial colonization, accelerating decomposition and reducing odor. In anaerobic digestion, a mat might serve as a fixed-film bioreactor, providing a stable surface for anaerobic bacteria, increasing biogas production and overall efficiency. The inherent aerobic properties of a well-designed mat might be leveraged to kickstart aerobic decomposition phases or to pre-treat feedstocks.
10. Modular, Reusable Oil Spill Cleanup and Remediation Barriers: Biochar's oleophilic (oil-attracting) and adsorptive properties make the biochar excellent for oil spill cleanup. A flexible, buoyant biochar mat might be deployed as a boom or absorbent pad to contain and soak up oil spills on water or land. The mat's structure would provide a large surface area for oil adsorption, and the biochar's porous nature would allow for some aerobic degradation of hydrocarbons over time, making the cleanup more efficient and potentially leading to less.

Further, the tackifier may be applied in layers to enhance its binding properties. This can be achieved by using multiple layers of the polymer material or incorporating additives like clay or bentonite to increase the binding strength.

Further, the anchor means may include geotextiles or fibrous materials interwoven with the biochar medium to provide additional structural support and prevent displacement.

The contamination prevention requires the effective breakdown of harmful substances in the soil. If the microorganisms present in the biochar medium are not sufficiently active or numerous, the apparatus may fail to achieve its intended purposes of contamination prevention and soil stabilization.

Further, the medium may be infused with specific strains of microorganisms that have been genetically engineered to produce enzymes capable of breaking down a wide range of contaminants, such as petroleum hydrocarbons or heavy metals.

Further, the medium may include nutrients tailored to enhance microbial growth. For example, adding ammonium nitrate or phosphorus-based fertilizers may increase the activity and population of beneficial microorganisms.

Further, the medium may be modified to create a nutrient gradient, where specific zones release different types of nutrients at varying rates to optimize microbial performance.

Rapid germination and root growth are critical for the establishment of vegetation in contaminated or unstable soils. If the seed mix used in the biochar medium does not promote effective germination, the system may fail to achieve its full potential in terms of soil stabilization and contamination prevention. Further, the seed mix may include species known for rapid growth under stress conditions, such as certain types of grasses or fast-growing shrubs. These plants can establish a root system quickly, providing structural support to the surrounding soil.

Further, the medium may be supplemented with biochar amendments that act as natural fertilizers, promoting seed germination rates. For example, biochar amended with compost extracts or nutrient-rich materials may enhance seed viability and germination efficiency.

Further, the medium may be designed to provide consistent moisture levels through controlled-release mechanisms, ensuring that seeds have adequate water for germination and early growth.

The absorption of atmospheric carbon dioxide by biochar is a key aspect of environmental benefits. However, if the biochar medium is not optimized for carbon sequestration, the system may fail to achieve its full potential in terms of reducing greenhouse gas emissions and promoting sustainable soil management practices. Further, the biochar may be manufactured with specific surface areas or porosities that maximize its ability to adsorb carbon dioxide. For example, biochar with a high surface area-to-volume ratio may be more effective at capturing CO₂ molecules.

Further, the medium may be designed to release captured carbon dioxide over time, ensuring a continuous reduction in greenhouse gas levels. This may be achieved through controlled-release mechanisms or the addition of catalysts that facilitate the reversal of carbon adsorption.

Further, the biochar may be blended with other materials, such as clay or humic acids, to enhance its carbon-sequestration capacity and stability.

Further, the mat-like structure may include modular components that may be easily detached and reattached to customize its size and shape for different applications. For example, interchangeable panels or sections may allow users to adjust the dimensions of the mat as needed.

Further, the design may incorporate sensors or monitoring systems that provide real-time feedback on the effectiveness of the barrier in different environmental conditions. This may enable users to fine-tune the system's performance based on specific challenges, such as high contamination levels or extreme weather conditions.

Further, the mat-like structure may be designed with built-in redundancy features, allowing the mat-like structure to function effectively even if certain parts of the barrier are damaged or compromised.

Further, the mat-like structure might be stacked to create an aerobic environment to support microorganisms.

Further, the mat-like structure may include natural pest-repellent additives, such as essential oils or certain plant extracts, that are incorporated into the biochar medium. These additives may create an unwelcome environment for pests, reducing their ability to damage the system.

Further, the medium may be treated with pesticides or insecticides specifically designed to target common soil pests without harming beneficial microorganisms. This may be achieved through controlled-release pest control systems or biodegradable pesticide formulations.

Further, the mat-like structure may incorporate physical barriers, such as raised edges or mesh layers, to prevent pests from accessing the biochar medium and causing damage.

Further, the biochar medium may be augmented with hydrogels or other water-retaining polymers that absorb and store moisture, ensuring consistent hydration for seeds and microorganisms. These materials may release water gradually over time, providing a sustained supply of moisture to the system (This same action can control moisture in attics, roofs, and walls).

Further, the mat-like structure may include porous design elements, such as vertical channels or macroscopic voids, that allow water to infiltrate and be stored within the medium. This may enhance water retention capacity while maintaining air circulation for root growth.

Further, the medium may be treated with surfactants or other materials that reduce surface tension, allowing water to penetrate more effectively into the biochar matrix and be retained for extended periods.

Further, the mat-like structure may incorporate sensors that detect the presence of specific contaminants, such as heavy metals or hydrocarbons, in the surrounding soil. These sensors may provide real-time data on contamination levels, enabling users to assess the system's performance and take corrective actions if necessary.

Further, the mat-like structure may be associated with a monitoring system. Further, the monitoring system may include a central monitoring unit that receives data from multiple sensor nodes embedded within the biochar medium. This allows for comprehensive tracking of contamination levels across different sections of the mat-like structure.

Further, the monitoring system may include automated response mechanisms, such as triggering the release of additional microorganisms or adjusting the composition of the biochar medium to enhance contamination breakdown.

Further, the mat-like structure may be designed with a built-in regeneration mechanism that periodically breaks down and reconstructs the biochar matrix. This may be achieved through the addition of specific microbes or enzymes that target aged or degraded biochar, allowing the mat-like structure to be reactivated into its original form.

Further, the system may incorporate a recycling process where used biochar is collected, processed, and reused in new matrices. This can reduce waste and provide a sustainable way to maintain the system's effectiveness over time. The regeneration process may involve the application of nutrient-rich amendments or additives that replenish the biochar matrix, restoring its ability to adsorb contaminants and support microbial activity.

Further, a biochar-based medium may include adaptive components that allow biochar-based medium to function effectively across a wide range of soil types. For example, the medium may be blended with materials that adjust its water-holding capacity based on the soil's existing properties, ensuring optimal performance regardless of the substrate.

Further, a mat-like structure may be incorporated with soil-type-specific additives or modifiers that enhance compatibility with different soils. For instance, adding bentonite to clayey soils or sand to sandy soils may improve the medium's ability to stabilize and retain water effectively.

Further, the mat-like structure may include adjustable layers or zones that cater to specific soil conditions. This may be achieved through modular designs that allow users to customize the composition of different sections of the mat based on local soil characteristics.

In some embodiments, the biochar is inoculated with one or more microorganisms. As used herein, “inoculation” refers to the intentional introduction of live microbial cultures onto the surface of the biochar to facilitate biological colonization and metabolic activity. The process may involve applying a microbial suspension or slurry via spraying, drenching, immersion, or injection techniques, either ex situ (prior to deployment) or in situ (after application to the contaminated site).

The porous and adsorptive nature of the biochar provides a favorable microenvironment for microbial attachment, proliferation, and sustained metabolic function. This biofilm formation or microbial colonization enhances the biochar's ability to degrade or transform contaminants, such as organic pollutants, heavy metals, or pathogens. Inoculated biochar may be especially advantageous in applications involving biostimulation or bioaugmentation strategies, where rapid onset of biological remediation is desired.

In other embodiments, the biochar is impregnated with one or more microorganisms. As used herein, “impregnation” refers to a process in which microorganisms are introduced into the internal pore network or matrix of the biochar through physical methods such as soaking, vacuum infusion, or capillary action. Unlike inoculation, which emphasizes microbial colonization and activity, impregnation focuses on the physical incorporation or entrapment of microbial cells within the biochar substrate.

This approach may be employed to encapsulate or preserve microorganisms, enabling their controlled release, gradual colonization, or protection from environmental stressors (e.g., desiccation, pH fluctuations, UV exposure). Impregnated biochar can serve as a microbial carrier or delivery vehicle, facilitating extended or delayed deployment of biological agents in environmental remediation systems.

The impregnation process may be optimized to retain microbial viability by controlling parameters such as moisture content, osmotic balance, and loading time. Optionally, the biochar may be supplemented with nutrients, binding agents, or protective coatings to enhance microbial survival and retention during storage and application.

The present disclosure describes a creation of an engineered environment for the development and protection of microorganism colonies. The mat is a control environment that protects the microorganisms from nature's elements. The components may be added or removed to improve the likelihood of survival.

In some embodiments, the absorbent medium further comprises at least one microorganism. The substrate and the absorbent medium incorporated with the substrate may collectively create an engineered environment configured to promote development and/or protect the at least one microorganism from one or more natural elements, such as ultraviolet exposure, desiccation, or temperature extremes. The engineered environment may be established through structural and compositional features, including protective coatings, moisture-retaining materials, nutrient infusion, and thermal insulation. Additionally, at least one of the substrate and the absorbent medium may be configured to removably receive at least one component that improves a likelihood of survival of the microorganism. Such components may include nutrient cartridges, protective films, hydration modules, or temperature-regulating inserts, which may be inserted, clipped, or replaceably attached. These features enable sustained microorganism viability and functionality, thereby enhancing the contaminant absorption and decomposition performance of the apparatus.

In some embodiments, the substrate and the absorbent medium are structurally and compositionally designed to collectively form an engineered microenvironment optimized for development, growth, and protection of the at least one microorganism. This microenvironment may regulate temperature, humidity, gas exchange, nutrient availability, and light exposure in a controlled manner, ensuring sustained microorganism viability even in harsh external conditions.

For instance, the substrate may comprise micro-porous layers configured to retain moisture while allowing oxygen permeability, thereby maintaining an optimal hydration level for microorganisms while supporting aerobic metabolic processes. In some embodiments, the absorbent medium may include micro-encapsulated nutrient reservoirs that gradually release nutrients over time, thereby supporting long-term survival and activity of the microorganisms.

In some embodiments, the substrate and absorbent medium may form a multi-layer protective architecture. For example:
1. An inner layer of the substrate may include thermal insulation fibers to protect microorganisms from temperature extremes.
2. A middle layer may be infused with bioactive compounds, including nutrients, antioxidants, or pH-stabilizing agents, creating a stable growth environment.
3. An outer layer may include UV-resistant coatings or hydrophobic membranes to shield the microorganisms from sunlight, heavy rainfall, or environmental toxins.

Such a layered design provides synergistic environmental control, ensuring the microorganisms remain viable and active over extended periods.

In certain embodiments, at least one of the substrate and the absorbent medium may be configured to removably receive adaptive components specifically designed to enhance microorganism survival. These components may include:
1. Replaceable nutrient cartridges containing carbon, nitrogen, and trace minerals essential for microorganism growth.
2. Moisture-retention modules such as hydrogel inserts that can absorb and slowly release water over time.
3. UV-protective films or covers configured to prevent microbial desiccation and DNA damage.
4. Temperature-regulating inserts using phase-change materials (PCMs) that absorb or release heat to maintain a stable internal temperature.

In some embodiments, the removable components may include microfluidic channels configured to deliver growth media, oxygen, or pH buffers directly to specific regions of the absorbent medium. These components may be biodegradable or replaceable, extending the operational life of the apparatus.

To further improve microorganism viability, the substrate or absorbent medium may include embedded sensors that monitor moisture levels, temperature, pH, and contaminant concentrations in real time. These sensors may communicate with the removable components to dynamically adjust environmental conditions. For example:
1. When moisture levels drop below a threshold, a hydrogel insert may automatically release water.
2. If temperatures exceed predefined limits, a PCM insert may activate to buffer thermal fluctuations.
3. When contaminants saturate the absorbent medium, a nutrient cartridge may trigger microorganism metabolic upregulation to accelerate contaminant degradation.

This integration of feedback-controlled components provides an unexpected synergistic effect between the microorganisms, substrate, and absorbent medium, making the apparatus more efficient and adaptive than conventional absorbent systems.

Unlike conventional absorbent materials, which passively retain contaminants, embodiments of the present apparatus actively manage contaminant breakdown. The engineered microenvironment sustains microorganisms capable of metabolizing absorbed contaminants into non-toxic by-products or stable carbon compounds.

In some embodiments, the removable components may supply specific enzymes or cofactors that accelerate the metabolic conversion of contaminants. For example:
1. Petroleum hydrocarbons may be broken down into simpler fatty acids.
2. Heavy metals may be sequestered via biomineralization facilitated by specialized microorganisms.
3. Volatile organic compounds (VOCs) may be metabolized into harmless alcohols or organic acids.

In some embodiments, the substrate and the absorbent medium may collectively form an engineered microenvironment optimized for the viability, development, and protection of at least one microorganism. The engineered environment may maintain stable temperature, moisture, nutrient availability, and protection from natural elements such as UV radiation and desiccation. In some embodiments, the substrate or absorbent medium may include multi-layer protective structures incorporating moisture-retaining materials, nutrient reservoirs, UV-shielding coatings, and thermal insulation. Additionally, at least one of the substrate and the absorbent medium may be configured to removably receive adaptive components, such as nutrient cartridges, hydrogel-based hydration modules, phase-change temperature inserts, or protective films. These components may be configured to dynamically regulate the internal environment, thereby improving the survival, metabolic activity, and contaminant-degradation performance of the microorganisms. The synergistic interaction between the substrate, absorbent medium, microorganisms, and removable components results in an apparatus that not only absorbs contaminants but actively facilitates their decomposition, thereby providing technical advantages over conventional passive absorbent systems.

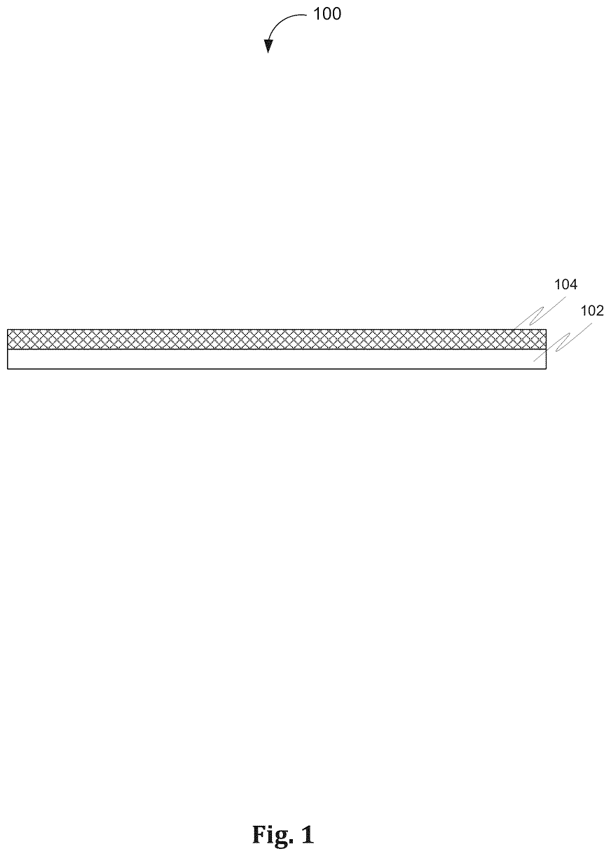

FIG. 1 illustrates a side view of an apparatus 100 for absorption of contaminants, in accordance with some embodiments.

Accordingly, the apparatus 100 may include a substrate 102 comprised of one or more of a biodegradable material and a non-biodegradable material. Further, the apparatus 100 may include an absorbent medium 104 incorporated with the substrate 102. Further, the apparatus 100 may be configured to be disposed on a surface. Further, the absorbent medium 104 includes a biochar. Further, the absorbent medium 104 may be configured for absorbing one or more contaminants from one or more of the surface and an environment associated with the surface. Further, the environment may include a surrounding of the surface, a surrounding of the apparatus 100, etc.

In some embodiments, the apparatus may be placed to regulate moisture of one or more of the surface and the environment.

In some embodiments, the absorbent medium 104 further includes one or more microorganisms. Further, the one or more microorganisms decompose the one or more contaminants absorbed by the absorbent medium 104.

In some embodiments, the biochar includes two or more pores. Further, the one or more microorganisms may be present in one or more of the two or more pores, and on a surface of the biochar.

In some embodiments, the biochar may be inoculated with the one or more microorganisms.

In some embodiments, the biochar may be impregnated with the one or more microorganisms.

In some embodiments, the absorbent medium 104 further includes a material. Further, the material may be decomposable into one or more material fragments. Further, at least one microorganism grows in one or more of the two or more pores, and on the surface of the biochar by utilizing one or more of the one or more material fragments.

In some embodiments, the one or more microorganisms include one or more mycelium spores. Further, the one or more mycelium spores germinate into one or more mycelia. Further, the one or more mycelia decompose the one or more contaminants absorbed by the absorbent medium 104.

In some embodiments, the absorbent medium 104 further includes one or more seeds. Further, the one or more seeds may germinate into one or more seedlings. Further, the one or more seedlings may absorb one or more carbon compounds from the environment.

In some embodiments, the apparatus 100 includes a mat. Further, the substrate 102 includes a sheet. Further, the absorbent medium 104 may be disposed on the sheet.

In some embodiments, the apparatus 100 includes a pod. Further, the substrate 102 includes a body of the pod. Further, the absorbent medium 104 may be incorporated with the body.

In some embodiments, the apparatus 100 further includes a second substrate 202. Further, the second substrate 202 may be comprised of one or more of the biodegradable material and the non-biodegradable material. Further, the absorbent medium 104 may be disposed between the substrate 102 and the second substrate 202.

In some embodiments, the absorbent medium 104 of a first thickness may be secured between the substrate 102 and the second substrate 202 using an organic tackifier.

In some embodiments, the absorbent medium 104 of a second thickness may be secured between the substrate 102 and the second substrate 202 using a needlepunching process. Further, the second thickness may be greater than the first thickness.

In some embodiments, the absorbent medium 104 of a second thickness may be secured between the substrate 102 and the second substrate 202 using one or more of a crochet technique, a knitting technique, a braiding technique, a quilting technique, an appliqué technique, and a serging technique.

In some embodiments, the biochar includes a granular biochar characterized by a granular form.

In some embodiments, the biodegradable material includes a non-woven biodegradable fabric.

In some embodiments, the one or more seeds germinate in the environment. Further, the one or more seeds include one or more regional seeds.

In some embodiments, the one or more microorganisms decompose the one or more contaminants into one or more sub-products. Further, the one or more microorganisms utilize the one or more sub-products as an energy source for one or more metabolic activities of the one or more microorganisms.

In some embodiments, the one or more microorganisms decompose the one or more contaminants into one or more carbon by-products. Further, the one or more carbon by-products may be stored in the absorbent medium 104.

In some embodiments, the one or more microorganisms grow into two or more microorganisms in the absorbent medium 104. Further, the two or more microorganisms decompose the one or more contaminants absorbed by the biochar.

Further, in some embodiments, the absorbent medium 104 further may include one or more microorganisms. Further, the one or more microorganisms one or more of consume and metabolize the one or more contaminants absorbed by the absorbent medium 104. Further, the one or more contaminants decompose based on one or more of the consumption and the metabolization of the one or more contaminants by the one or more microorganisms.

Further, in some embodiments, the one or more microorganisms may include one or more mycelium spores. Further, the one or more mycelium spores germinate into one or more mycelia. Further, the one or more mycelia one or more of consume and metabolize the one or more contaminants absorbed by the absorbent medium 104. Further, the one or more contaminants decompose based on one or more of the consumption and the metabolization of the one or more contaminants by the one or more mycelia.

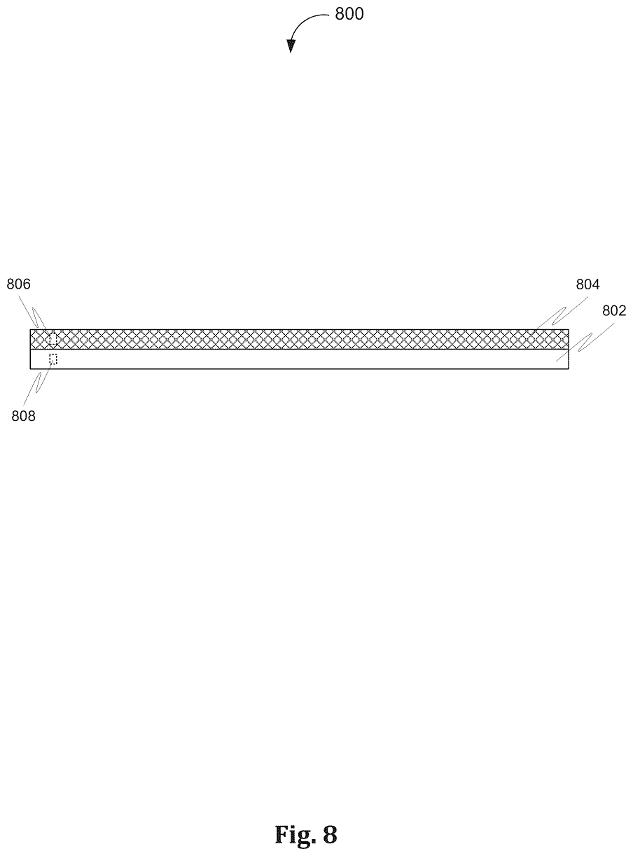

Further, in some embodiments, the absorbent medium 104 further may include one or more microorganisms. Further, the one or more microorganisms may include microorganism colonies. Further, the substrate 102 and the absorbent medium 104 incorporated with the substrate 102 create an engineered environment for one or more of development and protection of the one or more microorganisms from one or more natural elements. Further, one or more of the substrate 102 and the absorbent medium 104 may be configured to removably receive one or more components 806-808, as shown in FIG. 8, for improving a likelihood of a survival of the one or more microorganisms.

Further, in some embodiments, the one or more microorganisms one or more of consume and metabolize the one or more contaminants. Further, the one or more contaminants decompose into one or more sub-products based on the one or more of the consumption and the metabolization of the one or more contaminants. Further, the one or more microorganisms utilize the one or more sub-products as an energy source for one or more metabolic activities of the one or more microorganisms.

Further, in some embodiments, the one or more microorganisms one or more of consume and metabolize the one or more contaminants. Further, the one or more contaminants decompose into one or more carbon by-products based on the one or more of the consumption and the metabolization of the one or more contaminants. Further, the one or more carbon by-products may be stored in the absorbent medium 104.

In some embodiments, the surface includes a soil surface.

In some embodiments, the one or more contaminants include an organic matter.

In some embodiments, the one or more seeds include one or more regional-grass seeds.

In some embodiments, the biodegradable material includes a biodegradable fabric.

In some embodiments, the absorbent medium 104 includes a seed mix comprising two or more seeds. Further, the two or more seeds may be characterized by two or more seed types.

In some embodiments, the apparatus 100 protects the surface from one or more contaminations caused by the one or more contaminants by absorbing the one or more contaminants from the environment.

In some embodiments, the apparatus 100 remediates the surface associated with a contamination caused by the one or more contaminants by absorbing the one or more contaminants from the surface.

In some embodiments, the one or more contaminants include methane.

In some embodiments, the organic tackifier includes a plant-based polymer and a synthetic copolymer.

In some embodiments, the organic tackifier includes an additive comprised of one or more of a clay and a bentonite.

In some embodiments, the one or more microorganisms produce an enzyme capable of decomposing the one or more contaminants. Further, the one or more microorganisms decompose the one or more contaminants using the enzyme.

In some embodiments, the one or more microorganisms include a genetically engineered microorganism.

In some embodiments, the material includes a microorganism fuel.

In some embodiments, the material includes a nutrient adapted to enhance a growth of the one or more microorganisms.

In some embodiments, the one or more material fragments may be constituents of the material.

In some embodiments, the body of the pod includes an interior space. Further, the absorbent medium 104 may be disposed in the interior space.

In some embodiments, the absorbent medium 104 may be integrated with the substrate 102.

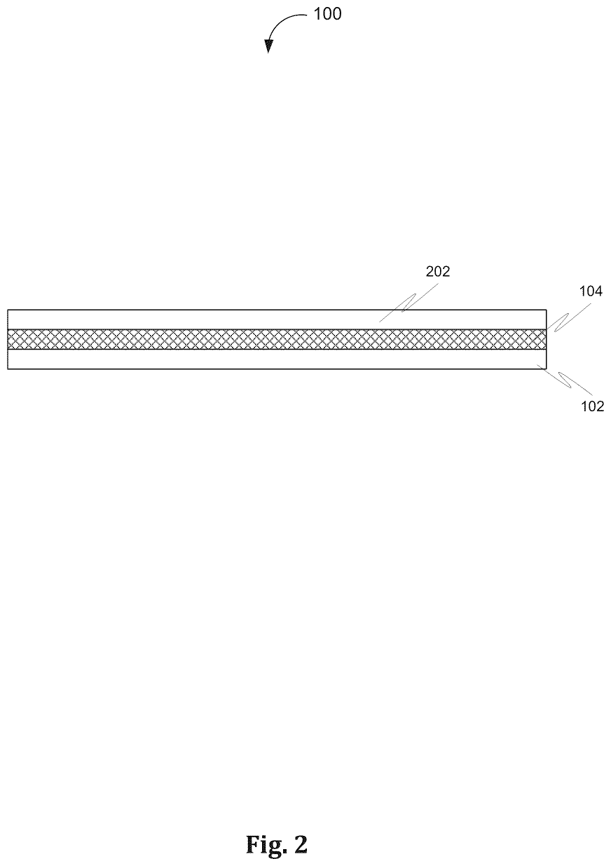

FIG. 2 illustrates a side view of the apparatus 100 for absorption of contaminants with the second substrate 202, in accordance with some embodiments.

Further, in some embodiments, the apparatus 100 includes a tackified mat. Further, the tackified mat may be used for thinner biochar applications. Further, the tackified mat may include the substrate 102 and the second substrate 202. Further, the substrate 102 and the second substrate 202 may be made from a non-woven biodegradable fabric. Further, the tackified mat may include the absorbent medium 104 comprising a granular biochar held in place between the substrate 102 and the second substrate 202 by an organic tackifier. Further, the absorbent medium 104 may include mycelium spores and/or regional grass seeds as needed in a specific application. Further, the absorbent medium 104 may be characterized by the first thickness.

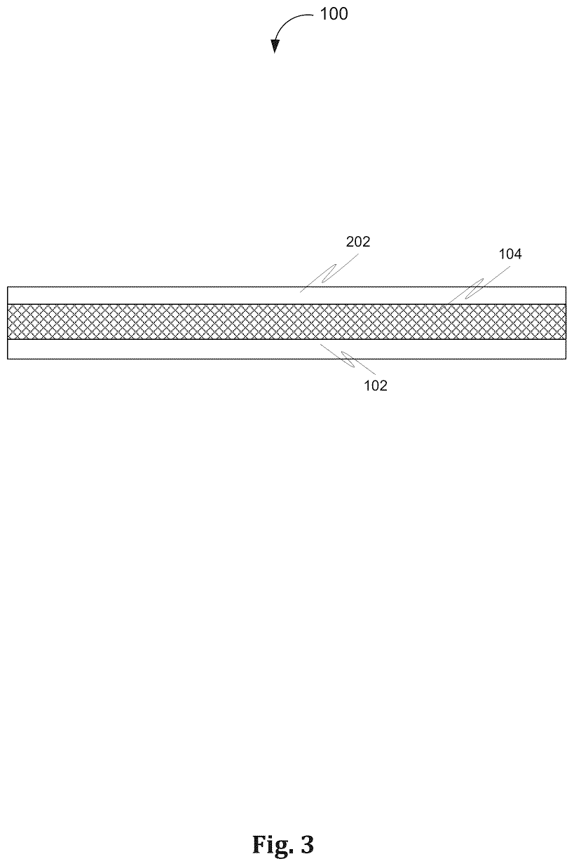

FIG. 3 illustrates a side view of the apparatus 100 for absorption of contaminants with the second substrate 202, in accordance with some embodiments.

Further, in some embodiments, the apparatus 100 includes a needlepunched mat. Further, the needlepunched mat may be used for thicker biochar applications. Further, the needlepunched mat may include the substrate 102 and the second substrate 202. Further, the substrate 102 and the second substrate 202 may be made from a non-woven biodegradable fabric. Further, the needlepunched mat may include the absorbent medium 104 comprising a granular biochar held in place between the substrate 102 and the second substrate 202 by the needlepunching process. Further, the absorbent medium 104 may include mycelium spores and/or regional grass seeds as needed in a specific application. Further, the absorbent medium 104 may be characterized by a second thickness.

In some embodiments, the first thickness may be half of the second thickness.

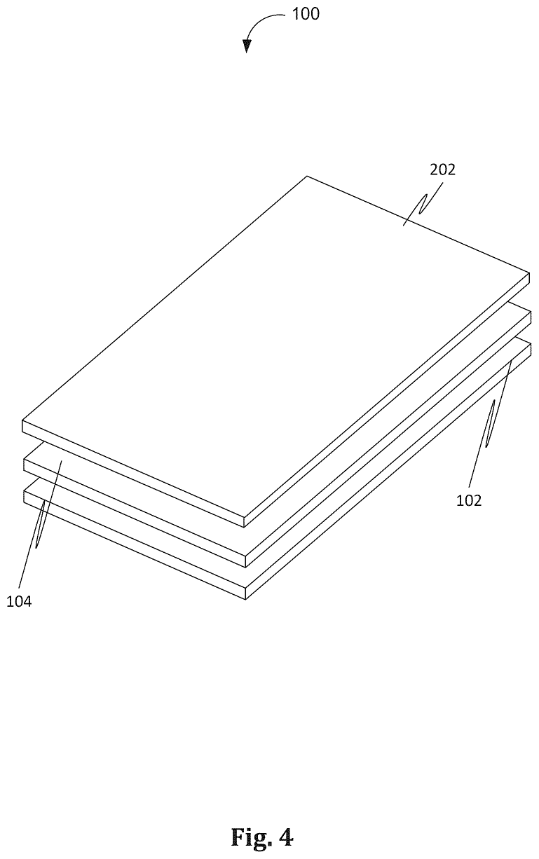

FIG. 4 illustrates an exploded view of the apparatus 100 for absorption of contaminants, in accordance with some embodiments.

Further, the apparatus 100 may include the second substrate 202. Further, the absorbent medium 104 may be secured between the second substrate 202 and the substrate 102.

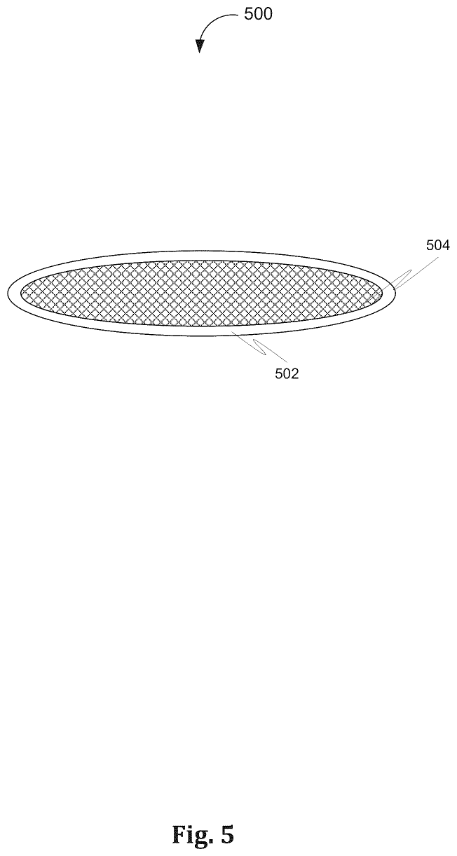

FIG. 5 illustrates an apparatus 500 for absorption of contaminants, in accordance with some embodiments.

Further, the apparatus 500 may include a pod. Further, the apparatus 500 may include a substrate 502. Further, the substrate 502 may include a body of the pod. Further, the body may include an interior space. Further, the apparatus 500 may include an absorbent medium 504. Further, the absorbent medium 504 may be disposed in the interior space of the body of the pod.

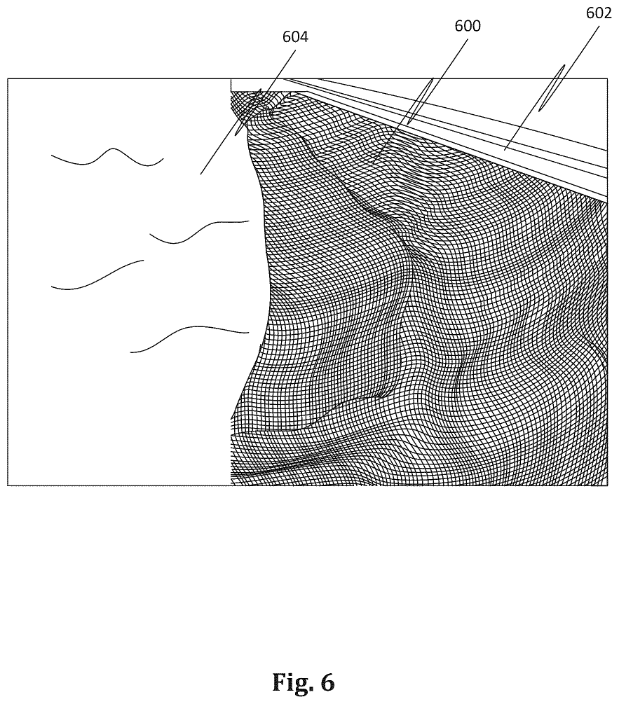

FIG. 6 illustrates an apparatus 600 disposed on a surface, in accordance with some embodiments.

Further, the apparatus 600 may be disposed on the surface of a roadside ground 604. Further, the roadside ground 604 corresponds to a ground level next to a roadway 602.

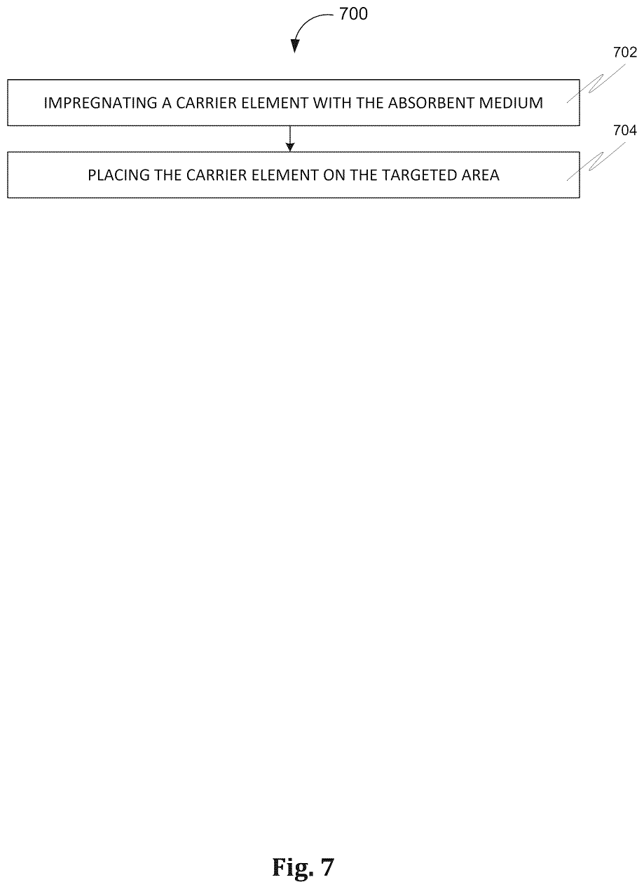

FIG. 7 illustrates a flow chart of a method 700 for facilitating preventing of soil contamination, in accordance with some embodiments.

Further, the method 700 may include a step 702 of impregnating a carrier element with the absorbent medium. Further, the method 700 may include a step 704 of placing the carrier element on a targeted area. Further, the absorbent medium may include a composition comprising the biochar inoculated with mycelium, the microorganism fuel, and a specific seed mix.

FIG. 8 illustrates a side view of an apparatus 800 for absorption of contaminants, in accordance with some embodiments.

Accordingly, the apparatus 800 may include a substrate 802 comprised of one or more of a biodegradable material and a non-biodegradable material. Further, the apparatus 800 may include an absorbent medium 804 incorporated with the substrate 802. Further, the apparatus 800 may be configured to be disposed on a surface. Further, the absorbent medium 804 includes a biochar. Further, the absorbent medium 804 may be configured for absorbing one or more contaminants from one or more of the surface and an environment. Further, the absorbent medium 804 further includes one or more microorganisms. Further, the one or more microorganisms decompose the one or more contaminants absorbed by the absorbent medium 804.

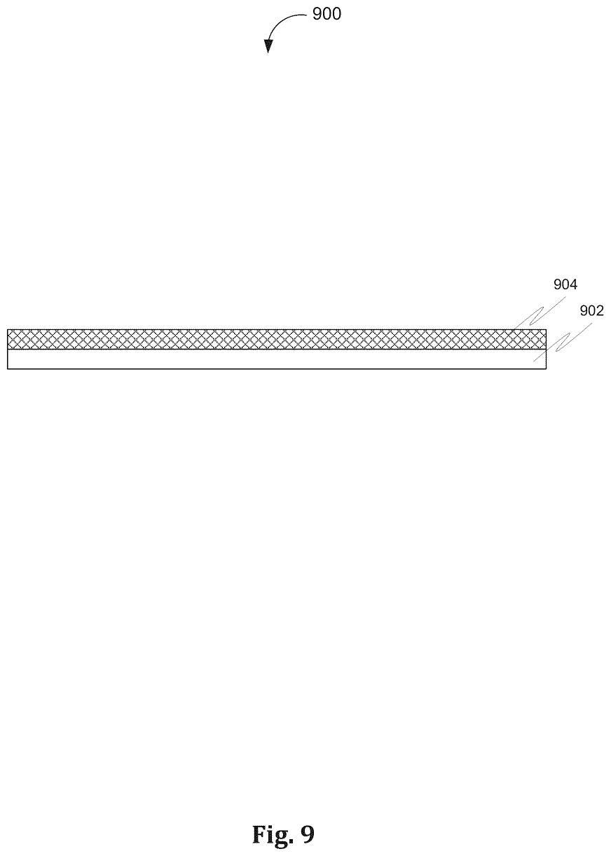

FIG. 9 illustrates a side view of an apparatus 900 for absorption of contaminants, in accordance with some embodiments.

Accordingly, the apparatus 900 may include a substrate 902 comprised of one or more of a biodegradable material and a non-biodegradable material. Further, the apparatus 900 may include an absorbent medium 904 incorporated with the substrate 902. Further, the apparatus 900 may be configured to be disposed on a surface. Further, the absorbent medium 904 includes a biochar. Further, the absorbent medium 904 may be configured for absorbing one or more contaminants from one or more of the surface and an environment associated with the surface. Further, the absorbent medium 904 further includes one or more seeds. Further, the one or more seeds may germinate into one or more seedlings. Further, the one or more seedlings may absorb one or more carbon compounds from the environment.

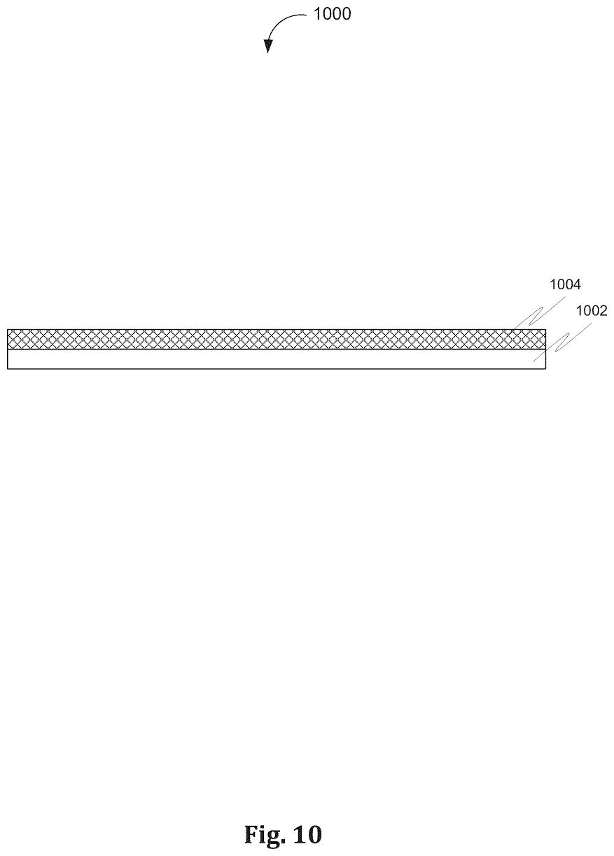

FIG. 10 illustrates a side view of an apparatus 1000 for providing a habitat for microorganisms, in accordance with some embodiments.

Accordingly, the apparatus 1000 may include a substrate 1002 comprised of one or more of a biodegradable material and a non-biodegradable material. Further, the apparatus 1000 may include an absorbent medium 1004 incorporated with the substrate 1002. Further, the apparatus 1000 may be configured to be disposed on a surface. Further, the absorbent medium 1004 includes a biochar. Further, the absorbent medium 904 further includes one or more microorganisms. Further, the apparatus 1000 may be configured to maintain a controlled environment condition for providing the habitat for one or more microorganisms.

In some embodiments, the one or more microorganisms may multiply and thrive in the habitat.

In some embodiments, the habitat may include an aerobic space.

In some embodiments, the habitat may include a “reef-like” space.

In some embodiments, the biochar may be characterized by one or more of a porous structure and a surface area configured to provide the habitat.

In some embodiments, the absorbent medium may be configured to absorb one or more contaminants from one or more of the surface and an environment associated with the surface. Further, the one or more microorganisms may decompose the one or more contaminants.

In some embodiments, the environment may include a contaminated water. Further, the one or more microorganisms may include an aerobic microorganism. Further, the one or more contaminants may include one or more of a pesticide, a heavy metal, and a pharmaceutical.

In some embodiments, the biochar may be configured to facilitate an air circulation within the mat to improve a degradation rate of decomposition of the one or more contaminants.

In some embodiments, the apparatus may include an aerobic layer disposed between the absorbent medium and the substrate. Further, the aerobic layer may be configured to facilitate air circulation within the mat to improve a degradation rate of decomposition of the one or more contaminants.

In some embodiments, the aerobic layer may include one or more tubes characterized by a permeability. Further, the one or more tubes may include a permeable tube.

In some embodiments, the surface may include a surface of one or more of a green roof, an attic, and a living wall.

In some embodiments, the apparatus may further include a retentive layer disposed on the absorbent medium. Further, the retentive layer may be configured to regulate moisture on one or more of the surface and the environment.

In some embodiments, the surface may include a surface of an agricultural field.

In some embodiments, the apparatus may be configured to release the biochar into soil. Further, the surface may include a soil surface.

In some embodiments, the apparatus may be configured to improve one or more of a soil structure, water retention, nutrient availability, root respiration, provide erosion control, allow water infiltration, and prevent soil runoff.

In some embodiments, the one or more contaminants may include a volatile organic compound, hydrocarbon, and ammonia.

In some embodiments, the apparatus may include a filter. Further, the filter may be used in one or more of a ventilation system, a waste treatment facility, and an industrial site.

In some embodiments, the apparatus may be configured to reduce an unpleasant odor and improve air quality.

In some embodiments, the apparatus may be configured to facilitates one or more of a plant growth, air filtration, water filtration, waste decomposition, and nutrient cycling.

In some embodiments, the surface may include a surface of one or more of a rain garden and storm-water swales. Further, the absorbing of the one or more contaminants may include absorbing the one or more contaminants from a runoff.

In some embodiments, the apparatus may be configured to absorb one or more beneficial compounds. Further, the apparatus may be further configured to release the one or more beneficial compounds to the surface.

In some embodiments, the release of the one or more beneficial compounds is characterized by a release rate. Further, the release rate is based on one or more characteristics of the biochar.

In some embodiments, the one or more characteristics may include a particle size and a density.

In some embodiments, the one or more beneficial compounds include one or more of a fertilizer, a nutrient, an agrochemical, and a beneficial microbe.

In some embodiments, the apparatus may be configured to reduce a nutrient leaching.

In some embodiments, the surface may include a surface of the wall and ceiling. Further, the environment may include an indoor environment. Further, the one or more contaminants may include formaldehyde and a volatile organic compound. Further, the apparatus may be configured to prevent a mold growth.

In some embodiments, the apparatus may be used in a composting pile. Further, the apparatus may facilitate microbial colonization, accelerate decomposition, and reduce odor.

In some embodiments, the apparatus may be used in an anaerobic digester. Further, the apparatus may provide a stable surface for anaerobic bacteria and increase biogas production.

In some embodiments, the one or more contaminants may include a petroleum compounds. Further, the apparatus may facilitate oil adsorption and an aerobic degradation of hydrocarbons.

Although the invention has been explained in relation to its preferred embodiment, it is to be understood that many other possible modifications and variations can be made without departing from the spirit and scope of the invention as hereinafter claimed.

What is claimed is:

1. An apparatus for absorption of contaminants, the apparatus comprising:
a substrate comprised of at least one of a biodegradable material and non-biodegradable material; and
an absorbent medium incorporated with the substrate, wherein the apparatus is configured to be disposed on a surface, wherein the absorbent medium comprises a biochar, wherein the absorbent medium is configured for absorbing at least one contaminant from at least one of the surface and an environment associated with the surface.

2. The apparatus of claim 1, wherein the absorbent medium further comprises at least one microorganism, wherein the at least one microorganism at least one of consumes and metabolizes the at least one contaminant absorbed by the absorbent medium, wherein the at least one contaminant decomposes based on at least one of the consumption and the metabolization of the at least one contaminant by the at least one microorganism.

3. The apparatus of claim 2, wherein the biochar comprises a plurality of pores, wherein the at least one microorganism is present in at least one of the plurality of pores, and on a surface of the biochar.

4. The apparatus of claim 3, wherein the biochar is inoculated with the at least one microorganism.

5. The apparatus of claim 3, wherein the biochar is impregnated with the at least one microorganism.

6. The apparatus of claim 2, wherein the absorbent medium further comprises a material, wherein the material is decomposable into one or more material fragments, wherein at least one microorganism grows in at least one of the plurality of pores, and on the surface of the biochar by utilizing at least one of the one or more material fragments.

7. The apparatus of claim 2, wherein the at least one microorganism comprises at least one mycelium spore, wherein the at least one mycelium spore germinates into at least one mycelium, wherein the at least one mycelium at least one of consumes and metabolizes the at least one contaminant absorbed by the absorbent medium, wherein the at least one contaminant decomposes based on at least one of the consumption and the metabolization of the at least one contaminant by the at least one mycelium.

8. The apparatus of claim 1, wherein the absorbent medium further comprises at least one seed, wherein the at least one seed germinates into at least one seedling, wherein the at least one seedling absorbs at least one carbon compound from the environment.

9. The apparatus of claim 1, wherein the apparatus comprises a mat, wherein the substrate comprises a sheet, wherein the absorbent medium is disposed on the sheet.

10. The apparatus of claim 1, wherein the apparatus comprises a pod, wherein the substrate comprises a body of the pod, wherein the absorbent medium is incorporated with the body.

11. The apparatus of claim 1, wherein the apparatus further comprises a second substrate, wherein the second substrate is comprised of the biodegradable material, wherein the absorbent medium is disposed between the substrate and the second substrate.

12. The apparatus of claim 11, wherein the absorbent medium of a first thickness is secured between the substrate and the second substrate using an organic tackifier.

13. The apparatus of claim 12, wherein the absorbent medium of a second thickness is secured between the substrate and the second substrate using a needlepunching process, wherein the second thickness is greater than the first thickness.

14. The apparatus of claim 11, wherein the biochar comprises a granular biochar characterized by a granular form.

15. The apparatus of claim 1, wherein the absorbent medium further comprises at least one microorganism, wherein the substrate and the absorbent medium incorporated with the substrate create an engineered environment for at least one of development and protection of the at least one microorganism from one or more natural elements, wherein at least one of the substrate and the absorbent medium is configured to removably receive at least one component for improving a likelihood of a survival of the at least one microorganism.

16. The apparatus of claim 2, wherein the at least one microorganism at least one of consumes and metabolizes the at least one contaminant, wherein the at least one contaminant decomposes into at least one sub-product based on the at least one of the consumption and the metabolization of the at least one contaminant, wherein the at least one microorganism utilizes the at least one sub-product as an energy source for at least one metabolic activity of the at least one microorganism.

17. The apparatus of claim 2, wherein the at least one microorganism at least one of consumes and metabolizes the at least one contaminant, wherein the at least one contaminant decomposes into at least one carbon by-product based on the at least one of the consumption and the metabolization of the at least one contaminant, wherein the at least one carbon by-product is stored in the absorbent medium.

18. An apparatus for absorption of contaminants, the apparatus comprising:
a substrate comprised of at least one of a biodegradable material and a non-biodegradable material; and
an absorbent medium incorporated with the substrate, wherein the apparatus is configured to be disposed on a surface, wherein the absorbent medium comprises a biochar, wherein the absorbent medium is configured for absorbing at least one contaminant from at least one of the surface and an environment, wherein the absorbent medium further comprises at least one microorganism, wherein the at least one microorganism at least one of consumes and metabolizes the at least one contaminant absorbed by the absorbent medium, wherein the at least one contaminant decomposes based on the at least one of the consumption and the metabolization of the at least one contaminant.

19. An apparatus for absorption of contaminants, the apparatus comprising:
a substrate comprised of at least one of a biodegradable material and a non-biodegradable material; and
an absorbent medium incorporated with the substrate, wherein the apparatus is configured to be disposed on a surface, wherein the absorbent medium comprises a biochar, wherein the absorbent medium is configured for absorbing at least one contaminant from at least one of the surface and an environment associated with the surface, wherein the absorbent medium further comprises at least one seed, wherein the at least one seed germinates into at least one seedling, wherein the at least one seedling absorbs at least one carbon compound from the environment.

20. An apparatus for providing a habitat for microorganisms, the apparatus comprising:
a substrate comprised of at least one of a biodegradable material and a non-biodegradable material; and
an absorbent medium incorporated with the substrate, wherein the apparatus is configured to be disposed on a surface, wherein the absorbent medium comprises a biochar, wherein the absorbent medium further comprises at least one microorganism, wherein the apparatus is configured to maintain a controlled environment condition for providing the habitat for one or more microorganisms.
